(19) United States
(12) Patent Application Publication
(10) Pub. No.: US 2022/0107266 A1
(43) Pub. Date: Apr. 7, 2022

(54) METHOD AND DEVICE FOR DETERMINING A SOLID STATE FORM OF WATER ON A ROADWAY SURFACE

(71) Applicant: Robert Bosch GmbH, Stuttgart (DE)

(72) Inventors: Andreas Baumgartner, Auenstein (DE); Sina Fella, Neuenstadt (DE); Stefan Kuntz, Flein (DE); Wolfgang Welsch, Heidelberg (DE)

(21) Appl. No.: 17/426,867

(22) PCT Filed: Apr. 1, 2020
(86) PCT No.: PCT/EP2020/059227

§ 371 Date: Jul. 29, 2021

(30) Foreign Application Priority Data
Apr. 25, 2019 (DE) 10 2019 205 903.1

(51) Int. Cl. G01N 21/31; G01N 21/3554; G01N 21/47

(52) U.S. Cl. CPC G01N 21/314; G01N 2021/4709; G01N 21/47; G01N 21/3554

(57) ABSTRACT

A method for ascertaining a solid physical state of water on a roadway surface. The method encompasses: emitting light having at least two predefined wavelengths or predefined wavelength ranges which differ from one another; receiving a signal representing an intensity of a portion of the emitted light which is scattered back by the roadway surface to an optical sensor; ascertaining a solid physical state of water on a roadway surface based on a ratio of received values for light intensities of the respective predefined wavelengths or predefined wavelength ranges within the signal; classifying the solid physical form of water on the roadway surface by reconciling absolute values of the signal with a first predefined threshold value and/or by reconciling a signal-to-noise ratio of the signal with a second predefined threshold value; and using the ascertained information regarding the solid physical state of the water in the transportation device.

### FIELD

The present invention relates to a method and an apparatus for ascertaining a solid physical state of water on a roadway surface.

### BACKGROUND INFORMATION

The related art includes systems for an automated or highly automated driving mode of means of transportation (i.e., transportation device), which use for reliable and safe control of the means of transportation, inter alia, information regarding currently existing environmental conditions. In order to ensure safe highly automated driving, for example, it is advantageous to ascertain as accurately as possible the coefficient of friction of a road that is to be traveled. The coefficient of friction is influenced in part by “intervening media” (i.e., media between a roadway surface and tires of the means of transportation), for example water, snow, ice, leaves, or oil, that are present on the road. Such media can be detected using a variety of sensors (e.g., cameras, acoustic or ultrasonic sensors, or optical sensors operating in the infrared range). Optical sensors operating in the near infrared range (approx. 800 nm to 3000 nm) can suitably evaluate a diffuse and/or directional reflection of actively emitted light of several wavelengths or wavelength ranges. These detected wavelengths or wavelength ranges differ in that they contain absorption lines of different intensity in the optical spectrum of water in all aggregate states (liquid, ice, snow, or mixed states). It is thereby possible to distinguish dry from not-dry roads, to categorize individual intervening media as physical states of water, and even to determine layer thicknesses of a respective intervening medium. Intensities and intensity ratios, in particular, are evaluated for this purpose, by way of either comparisons, threshold values, or machine learning methods. A reliable distinction, advantageously usable for the automated driving mode, between a snow-covered and an ice-covered roadway surface easily results in misclassifications, however, because of the similarities of the spectra of snow and of ice.

German Patent No. DE 0000027 12199 C2 describes an apparatus for alerting a driver of a motor vehicle to a slippery road, characterized by: a light source by which light of a specific wavelength is emitted onto the roadway surface; a receiver by which the light reflected from the roadway is convertible into a corresponding electrical signal; and a warning device by way of which the electrical signal occurring in the context of icing on the roadway is recognizable by the motor-vehicle driver.

German Patent No. DE 000004133359 C2 describes a method and an apparatus for measuring a thickness of a water layer present on a roadway. For this, a light beam having an infrared spectral component is emitted by way of a light source onto the roadway. The light scattered back from the roadway, which has penetrated through a water layer when one is present, is selectively sampled at at least two wavelengths located in the near infrared range. From the amplitudes of the selectively sampled back-scattered light currents, the thickness of the water layer is determined and is displayed by way of an indicating unit.

German Patent Application No. DE 000019506550 A1 describes methods and an apparatus for warning of hazards on traffic routes, but also on non-freeze-protected components of aircraft and machines of all kinds, caused by ice formation, such as freezing moisture and/or supercooled surfaces, by spectrum-analytical measurement and computer-assisted chemometric evaluation of the transmission and reflection properties of water, or of a solidifiable protic liquid or solution that behaves like water, as a function of the degree of crystallization of the molecular structure present in the liquid and/or solid aggregate state.

### SUMMARY

In accordance with a first aspect of the present invention, a method is provided for ascertaining a solid physical state of water on a roadway surface, which method can be used in particular to distinguish between ice and snow on a roadway surface. In accordance with an example embodiment of the present invention, in a first step of the method according to the present invention, light of a light source of an optical sensor of a means of transportation (i.e., a transportation device) is emitted at a predefined angle onto a roadway surface.

In accordance with an example embodiment of the present invention, the light source is configured to emit light having at least two predefined wavelengths or wavelength ranges which differ from one another. In the interest of a simplified description, the term “predefined wavelength range” will also be used below as a substitute for the “predefined wavelength.” The light source can encompass a single light-emitting means (i.e., light emitting device) or a plurality of light-emitting means. In other words, the light for the at least two predefined wavelength ranges can be generated either by a broadband light-emitting means (which encompasses the at least two predefined wavelength ranges) or by several narrowband light-emitting means, each light-emitting means being configured to emit light in one of the respective predefined wavelength ranges.

The means of transportation can be, for example, a road vehicle (e.g., a motorcycle, passenger car, bus, truck) or a rail vehicle or an aircraft or a waterborne vehicle. The light source of the optical sensor can be, for example, a laser light source or an LED light source which is embodied in particular to emit near-infrared light whose wavelength or wavelength range is preferably in the range between 800 nm and 3000 nm. The method according to the present invention can moreover also be carried out in principle using further types of light source and/or further wavelengths or wavelength ranges. The optical sensor can be disposed in principle at any positions on the means of transportation, as long as the light emitted by the sensor strikes the roadway surface at the aforementioned predefined angle and the light of the light source of the optical sensor which is scattered by the roadway surface can be received at least in portions in the optical sensor. A suitable position for placement of the optical sensor can be, for example, a position in or on a front spoiler or in the underbody region of the means of transportation, at which the optical sensor can be mounted and can be oriented downward toward the roadway surface. The optical sensor can furthermore also, for example, be disposed in a lower region of a front spoiler and/or in the region of a wheel well of the means of transportation. The predefined angle of the optical sensor with reference to the roadway surface (i.e., the angle at which the light emitted by the optical sensor strikes the roadway surface) can be an angle of between 10° and 54°, in particular an angle of between 15° and 35°, and preferably an angle of 20°. Be it noted that the values described herein for the predefined angle of the optical sensor are values advantageously usable in conjunction with the method according to the present invention, but that for purposes of the present invention they are not limited to those recited here. In particular, by using an angle greater than or equal to 10° it is possible to avoid a proportion of direct reflections of the emitted light from the roadway surface which may be too high for the method according to the present invention, and which can interfere with detection of the roadway surface or of the intervening medium on the roadway surface. The optical sensor can furthermore be connected informatically via an onboard network of the means of transportation to an evaluation unit according to the present invention of the means of transportation, in order to be controlled by the evaluation unit and/or for processing by way of the evaluation unit, in the context of the method according to the present invention, of signals detected by the optical sensor. In other words, this method step, and those described hereinafter, of the method according to the present invention can be carried out by way of the evaluation unit. The evaluation unit according to the present invention can be a constituent of an independent control unit or a constituent of an existing control unit of the means of transportation. The evaluation unit can furthermore also be a constituent of the optical sensor itself. In other words, the signals generated by the sensor can be transferred in the form of (preprocessed) raw values to an evaluation unit disposed remotely from the sensor, or to an evaluation unit disposed inside the sensor.

In a second step of the method according to an example embodiment of the present invention, a signal of a light detector of the optical sensor, representing an intensity of that portion of the emitted light which is scattered back by the roadway surface to the optical sensor, is received by the evaluation device according to an example embodiment of the present invention. The signal generated by the optical sensor can be outputted by the sensor in the form of a digital or analog signal. The evaluation unit can receive the signal via a suitable digital or analog signal interface and can store a digital signal directly, and an analog signal after A/D conversion, in a internal memory unit, or one linked externally to the evaluation unit, for downstream processing. The light detector can encompass a single detector or a plurality of detectors; the individual detector can be a broadband detector that is configured to receive the at least two predefined wavelength ranges, while the plurality of detectors can each be configured to receive one of the predefined wavelength ranges per detector.

In the example method according to the present invention, by way of a suitable combination of light source and light detector, respective intensities of the backscattered light in the respective wavelength ranges can be received independently of one another. This can be achieved, for example, by the combination of a plurality of light-emitting means and a corresponding plurality of detectors. Alternatively or additionally, a plurality of light-emitting means can also be combined with a broadband detector by the fact that the measurements in the respective wavelength ranges occur successively, so that the light intensities received by the detector can be associated with the respective light-emitting means. Also alternatively or additionally, a broadband light-emitting means can be combined with a broadband detector by the fact that the signal generated by the detector is subjected to filtering in the respective wavelength ranges.

In a third step of the method according to an example embodiment of the present invention, a solid physical state of water on a roadway surface is ascertained on the basis of a ratio of received values for light intensities of the respective predefined wavelengths or predefined wavelength ranges within the signal. In other words, in this method step, an evaluation of relative values, i.e., ratios of absolute values of different predefined wavelengths or predefined wavelength ranges, of the intensity of the scattered light detected by the light detector, takes place. The predefined wavelengths or predefined wavelength ranges preferably represent characteristic absorption lines or absorption line ranges of ice and/or snow. The predefined wavelengths or predefined wavelength ranges can furthermore also represent characteristic absorption lines or absorption line ranges of liquid water. Be it noted that the absorption lines are substantially identical between ice and snow, while the absorption lines between water and ice, and correspondingly also between water and snow, are shifted with respect to one another in the spectrum. The background of considering the ratios of the absolute values of different predefined wavelengths or predefined wavelength ranges is that considering only absolute values of the light intensities detected by the optical sensor can result in misclassifications due to intensity fluctuations resulting from interfering influences. Such misclassifications can occur, for example, when a suspension system of the means of transportation deflects and the distance between the optical sensor and the roadway surface thereby changes. A further example of a cause of misclassifications when considering only absolute values can be roadway markings that can strongly backscatter similarly to snow present on the roadway, which can result in each case in large absolute values. Such roadway markings therefore cannot be unequivocally distinguished from the presence of snow based on consideration only of absolute values of the light intensities. An example embodiment of the method according to the present invention therefore provides, as described above, firstly for ascertaining a solid physical state of water on the roadway surface, which can be accomplished highly reliably based on relative values. “Absolute values” and “relative values” are to be understood here in particular as absolute values and relative values of amplitude values and/or energies of the signal in the optical spectrum, i.e., of (portions of) the envelope curve of the optical spectrum. In other words, based on a knowledge of the emitted wavelength or emitted wavelength range of the light, and a subsequent evaluation of the intensity of the received light, it is possible to conclude whether or not absorption is present in a respective predefined wavelength range. For the case in which no characteristic absorption lines for ice and/or snow are ascertained in this method step, a solid physical state of water cannot be ascertained on the roadway surface. An information item as to the fact that a solid physical state of water cannot be ascertained on the roadway surface can be stored by the evaluation unit in the memory unit linked to the evaluation unit. For the case in which, on the basis of the ratio of received values for light intensities of the respective predefined wavelengths or predefined wavelength ranges within the signal, it is also not possible to ascertain any characteristic absorption lines for liquid water, the roadway surface can be classified by the evaluation unit as dry. An information item regarding a dry roadway state of this kind can also be stored by the evaluation unit in the memory unit linked to the evaluation unit.

For the case in which a solid physical form of water on the roadway surface has been ascertained by the evaluation unit in the preceding method step, in the fourth step of the method according to the present invention the solid physical form of water (ice or snow) on the roadway surface is classified. Classification is accomplished by reconciling absolute values of the signal with a first predefined threshold value and/or by reconciling a signal-to-noise ratio of the signal with a second predefined threshold value. It can furthermore be useful to use a plurality of predefined first threshold values and/or a plurality of predefined second threshold values, which are each adapted to their corresponding wavelength ranges. A wavelength-dependent threshold value can be ascertained via suitable methods, for example via weighted averaging of the signal of all wavelengths present in the sensor. The first and/or second predefined threshold value can preferably be stored in the memory unit linked to the evaluation unit, and can be read out by the evaluation unit from the memory unit at the given point in time, and used. As a result of classification of the physical state of the water based on the absolute values of the signal, ice can be distinguished from snow in particular by the fact that high absolute values of the signal as a rule indicate a high percentage content of snow that is present, whereas low absolute values of the signal as a rule indicate a high percentage concentration of ice that is present. Because the water present on the roadway surface can also represent mixed states of the physical forms of ice, snow, or liquid, a corresponding mixed state of the water can also be ascertained from the levels of respective absolute values of the signal. Be it noted that classification of the liquid physical state of the water can be effected in particular by way of the above-described consideration of the location of the absorption lines in the spectrum of the signal of the optical sensor. This can be carried out in the course of the fourth method step described here, and/or already in the third method step. The method according to the present invention can thereby make possible a classification of the current state of the roadway surface into the states of “dry,” “wet,” and “water in solid form,” the water in solid form being capable of being categorized, in terms of a current physical state of the water, into the “snow” or “ice” states or mixed forms based thereon.

Alternatively or additionally, the distinction between ice and snow, as described above, can be carried out on the basis of the signal-to-noise ratio of the signal of the optical sensor. For the case in which the evaluation unit ascertains a high signal-to-noise ratio (i.e., a low proportion of noise in relation to useful signal) in the signal of the optical sensor, a current physical state of the water can be categorized as “snow.” For the case in which, conversely, the evaluation unit ascertains a low signal-to-noise ratio in the signal (i.e., a high proportion of noise in relation to useful signal), a current physical state of the water can be categorized as “ice.” The noise proportion in the signal for snow is, on the one hand, lower because of higher absolute values. The signal for ice, on the other hand, is more location-dependent. This is because on the one hand the signal of a roadway surface covered with ice is influenced by a quantity of air bubbles enclosed in the ice. On the other hand, in the context of an ice-covered roadway, the roadway surface itself makes a greater contribution to the signal than in the case of a snow-covered roadway, since the near-infrared light becomes highly scattered in snow, and with ice the light scattering processes occur predominantly at the air bubbles enclosed in the ice. As a result, the light emitted by the optical sensor reaches the substrate with a significantly higher intensity, for the same layer thickness, in the case of an ice-covered roadway as compared with a snow-covered roadway surface. Because in most cases the roadway surface is an asphalt surface that has a definite macrostructure, this as a rule produces a more greatly location-dependent signal and thus a correspondingly higher noise proportion in the signal. Be it noted that the influence of different speeds of the means of transportation can also be taken into account in the course of evaluation of the signal-to-noise ratio, for example by the fact that the noise proportion of the signal is normalized to a respective speed of the means of transportation.

In addition, corresponding mixed forms between ice and snow can also be identified by the evaluation unit on the basis of a respective magnitude of the signal-to-noise ratio. In order to determine respective mixed forms, a plurality of first and/or second threshold values, which each represent a specific mixed form of physical states of the water, can be stored in the memory unit. Respective results of the classification on the basis of the absolute values and/or the signal-to-noise ratio can then be used individually in the means of transportation or can be combined, before further use ,in suitable fashion into a single result.

In a fifth step of the method according to an example embodiment of the present invention, the ascertained information regarding the solid physical state of the water is used in the means of transportation. For that purpose, the evaluation unit according to the present invention can transfer the respectively ascertained information via the vehicle electrical system of the means of transportation to one or more receiver control devices for that information. Appropriate receiver control devices are, for example, a control device for a highly automated driving mode in order to adapt current control of the means of transportation, or an onboard computer system for outputting information regarding the solid physical state of the water to a driver of the means of transportation. It is furthermore also possible for the ascertained information to be used in further control devices of the means of transportation (e.g., in driver assistance systems).

Preferred refinements of the present invention are disclosed herein.

In an advantageous example embodiment of the present invention, an information item regarding a current degree of spring deflection of a suspension system of the means of transportation is additionally taken into account upon reconciliation of the absolute value of the signal with the first predefined threshold value. A reliability of the result of the evaluation of the absolute values of the signal can thereby be improved. A respective current existing degree of spring deflection of the suspension system can be detected, for example, by way of an acceleration sensor and/or a ride height sensor and/or an inertial sensor of the means of transportation, and can be ascertained in respectively corresponding control devices (e.g., by the evaluation device according to the present invention). Based on the ascertained degree of spring deflection of the means of transportation, undesired changes caused thereby in the signal of the optical sensor can be correspondingly compensated for by the evaluation unit. In the course of compensation, respective values of the signal of the optical sensor, and/or the first and/or second threshold values, can be adapted in suitable fashion by the evaluation unit. Alternatively, the signal generated by the optical sensor can also be discarded in phases of a spring deflection of the suspension system of the means of transportation which are unfavorable for the method according to the present invention, or can be correspondingly given less weight in the context of a possible averaging over several measured values. In other words, no current information regarding the solid physical state of the water is ascertained in such phases. Instead, the information ascertained before the occurrence of such a phase can continue to be used without modification during such a phase.

In a further advantageous example embodiment of the present invention, the classification of the solid physical state of the water on the roadway surface is additionally carried out on the basis of further sensors of the means of transportation. For example, signals of a camera detecting the roadway and/or of an acoustic transducer and/or of a temperature sensor and/or of an ultrasonic sensor of the means of transportation, which can be received by the evaluation unit according to the present invention via the vehicle electrical system, can be used for this purpose. A distinction between ice and snow on the basis of the signal of the camera can be made, for example, by the fact that different light reflections from the roadway surface which are generated by ice and snow are ascertained in the evaluation unit.

In a further advantageous example embodiment of the present invention, a layer thickness of the water in its respective solid physical state is additionally ascertained on the basis of the signal. For this, a logarithmic intensity ratio of two wavelengths or wavelength ranges of the signal of the optical sensor of the means of transportation can preferably be evaluated by way of the evaluation unit. Based on a result of this evaluation, a corresponding layer thickness of the water in its respective solid physical state can be determined. The ascertained information regarding the layer thickness can advantageously be used, for example, in conjunction with the classification of the solid physical state of water on the roadway surface, since different spectra for the signal can result depending on a respective layer thickness.

In a further advantageous example embodiment of the present invention, the solid physical state of water on the roadway surface can be ascertained on the basis of a method for machine learning. Conventional algorithms from the related art (e.g., support vector machine, random forest, or a deep learning method of an artificial neural network) for monitored or partly monitored learning, which can be implemented as a component of the above-described computer program, can preferably be used for this purpose. The different physical states of the water can thereby be trained by the method for machine learning by way of the evaluation unit according to the present invention in the course of the evaluation of laboratory reference measurements (on a broadband basis or with various narrowband wavelengths or wavelength ranges), simulations, and/or one or several training trips of the means of transportation and/or a dedicated training means of transportation. A configuration of the algorithm trained in this fashion can then be used in the means of transportation itself and/or transferred to further means of transportation (e.g., in the course of a process for manufacturing the means of transportation) and used therein.

In a further advantageous embodiment of the present invention, a confidence value for the solid physical form of water is additionally ascertained. The confidence value can correspond, for instance, e.g., in conjunction with machine learning, to a distance from a separating plane of different classes.

The noise of the measured values, or the magnitude of the measured values, can also be taken into account in the confidence value.

The confidence value is then used in the means of transportation by the fact that it is utilized, for example, in the above-described control device for a highly automated driving mode and/or in one or several driver assistance system(s). Alternatively or additionally, the confidence value can also be utilized in the course of the output, to the user of the means of transportation, of information regarding the solid physical state of the water on the roadway surface.

In a further advantageous embodiment of the present invention, a plurality of signals of the optical sensor, which have each been received at different positions of the means of transportation, are taken into account upon classification of the solid physical state of the water. The greater positional dependence of the signal in conjunction with an ice-covered roadway as compared with a snow-covered roadway can thereby be identified not only in the above-described signal-to-noise ratio of a single measured signal of the optical sensor, but also by way of a greater variation in signal values between different measured signals of the optical sensor.

According to a second aspect of the present invention, an apparatus for ascertaining a solid physical state of water on a roadway surface is provided. In accordance with an example embodiment of the present invention, the apparatus encompasses an evaluation unit having a data input and a data output, and can be a component of an existing control device or an independent control device of the means of transportation. The evaluation unit can furthermore be configured, for example, as an ASIC, FPGA, processor, digital signal processor, microcontroller, or the like, and can be informatically linked to an internal and/or external memory unit in which data received and/or calculated by the evaluation unit can be stored for subsequent processing. The evaluation unit can furthermore be configured to execute above-described method steps according to the present invention on the basis of a computer program that implements the method steps. The evaluation unit is further configured, in conjunction with the data output, to emit light of a light source of an optical sensor of a means of transportation at a predefined angle onto a roadway surface, the light source being configured to emit light having at least two predefined wavelengths or predefined wavelength ranges that differ from one another. The evaluation unit can be informatically connected for that purpose to the optical sensor via (a portion of) a vehicle electrical system of the means of transportation. The (portion of the) vehicle electrical system connecting the two components can use, for example, a vehicle bus system known from the existing art (e.g., CAN, MOST, FlexRay, Ethernet, etc.). In conjunction with the data input the evaluation unit is further configured to receive a signal of a light detector of the optical sensor representing an intensity of that portion of the emitted light which is scattered back by a roadway surface to the optical sensor. The evaluation unit is furthermore configured to ascertain a solid physical state of water on the basis of a ratio of received values for light intensities of the respective predefined wavelengths or predefined wavelength ranges within the signal. The evaluation unit is furthermore configured to classify a solid physical state of water on the roadway surface by reconciling absolute values of the signal with a first predefined threshold value and/or by reconciling a signal-to-noise ratio of the signal with a second predefined threshold value. Once again in conjunction with the data output, the evaluation unit is configured to use the ascertained information regarding the solid physical state of the water in the means of transportation. For this, the evaluation unit can transfer the ascertained information, via the (portion of the) vehicle electrical system of the means of transportation, to one or several receiver control device which, on the basis of the information, can, for example, adapt a highly automated control mode of the means of transportation to the ascertained environmental conditions. It is thereby possible, for example when slippery ice and/or snow is present, to automatically reduce a speed of the means of transportation so that, inter alia, an accident risk for the means of transportation can be decreased.

### BRIEF DESCRIPTION OF THE DRAWINGS

Exemplifying embodiments of the present invention are described below in detail with reference to the figures.

FIG. 1 is a flow chart illustrating steps of an exemplifying embodiment of a method according to the present invention.

FIG. 2 is a schematic overview of an apparatus according to the present invention in conjunction with a means of transportation.

FIG. 3a shows a comparative example of a spectrum of a first signal and a second signal of an optical sensor of a means of transportation.

FIG. 3b shows a comparative example of a third signal and a fourth signal of an optical sensor of a means of transportation.

### DETAILED DESCRIPTION OF EXAMPLE EMBODIMENTS

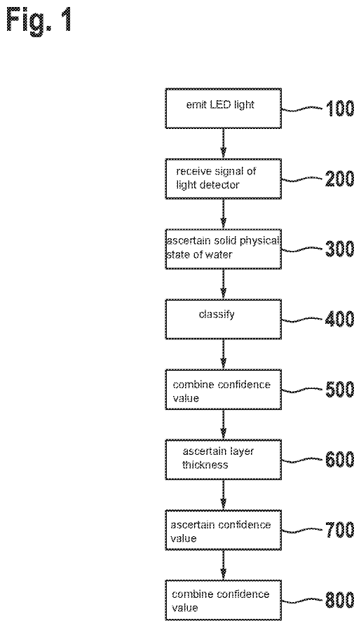

FIG. 1 is a flow chart illustrating steps of an exemplifying embodiment of a method according to the present invention for ascertaining a roadway state. In step 100, light of an LED light source of an optical sensor of a means of transportation (i.e., transportation device) is emitted, at a predefined angle of 20°, onto a roadway surface being traveled on by the means of transportation. The LED light source is configured to emit light having at least two predefined wavelengths or predefined wavelength ranges that differ from one another. The optical sensor has control applied to it by way of an evaluation unit according to the present invention, which here is a microcontroller. The evaluation unit according to the present invention is informatically connected for that purpose to the optical sensor via a FlexRay bus of the means of transportation. In step 200, the evaluation unit receives a signal of a light detector of the optical sensor, representing an intensity of a portion of the emitted light which was scattered back by the roadway surface to the optical sensor. The signal is received in the evaluation unit in the form of digital data and is stored by the evaluation unit in an internal memory unit of the evaluation unit. In step 300, a solid physical state of water on the roadway surface is to be ascertained by the evaluation unit on the basis of a ratio of received values for the respective predefined wavelengths or predefined wavelength ranges within the signal. In step 400, the solid physical state of the water on the roadway surface is classified by way of the evaluation unit. For that purpose, absolute values of the signal are reconciled with a first predefined threshold value stored in the memory unit. Because the absolute values of the signal are low in this exemplifying embodiment, the result of the reconciliation is that the roadway is ice-covered. In step 600, the layer thickness of the ice on the roadway surface is ascertained. In the subsequent step 700, a confidence value for a reliability of the classification of the solid physical state of the water is ascertained. In step 500 and step 800, the confidence value is combined with the result for the solid physical state of the water, and is transferred in the form of a bus signal to a control device for a highly automated driving mode. In this control device the result is then used, in consideration of the confidence value, to adapt the control function of the means of transportation.

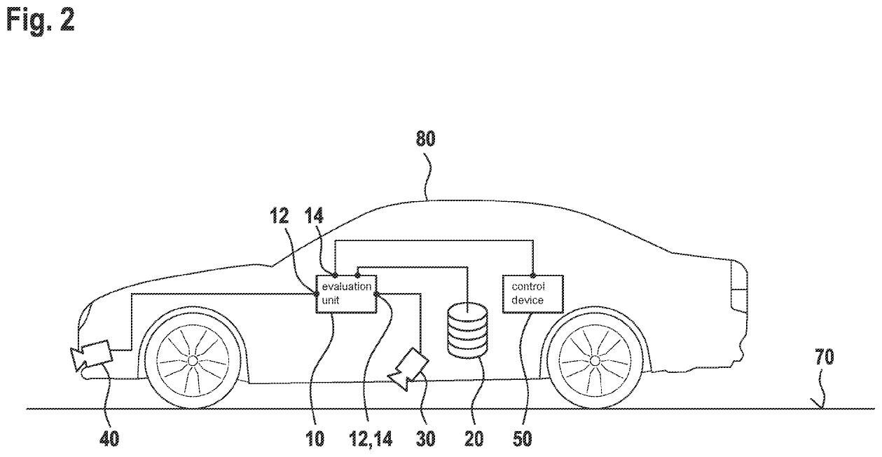

FIG. 2 is a schematic overview of an apparatus according to the present invention in conjunction with a means of transportation 80. The apparatus according to the present invention encompasses an evaluation unit 10, which here is a microcontroller. Evaluation unit 10 is informatically connected to an external memory unit 20 and is configured to execute above-described method steps according to the present invention on the basis of a computer program. Evaluation unit 10 is furthermore connected via a data input 12 and a data output 14, via a portion of a vehicle electrical system of means of transportation 80, to an optical sensor 30 that is oriented at an angle of 20° with respect to roadway surface 70 and is disposed in the underbody region of means of transportation 80. The portion of the vehicle electrical system is implemented here on an Ethernet basis. A camera 40, which is disposed in the front region of means of transportation 80 and detects roadway surface 70, is likewise connected informatically to evaluation unit 10 via the aforesaid portion of the vehicle electrical system. Based on a signal of camera 40, evaluation unit 10 is capable of plausibilizing a roadway state to be ascertained by way of the method according to the present invention. Evaluation unit 10 is furthermore connected informatically via data output 14, via the portion of the vehicle electrical system, to a control device 50 for a highly automated driving mode. A result of the method according to the present invention, ascertained by evaluation unit 10 on the basis of the method according to the present invention, is transferred in the form of a digital signal, via data output 14, to control device 50 for the highly automated driving mode. Control device 50 for the highly automated driving mode uses the result of the method according to the present invention to adapt a current control function for means of transportation 80.

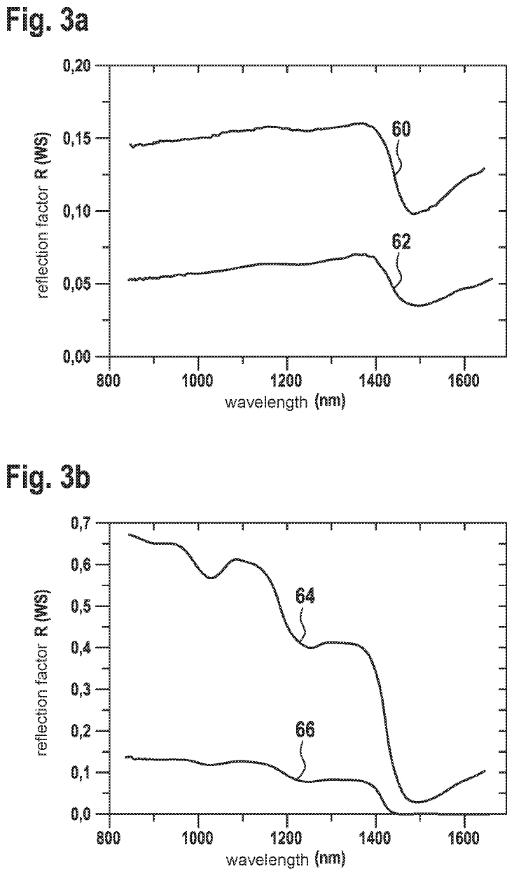

FIG. 3a shows a comparative example of a spectrum of a first signal 60 detected in broadband fashion, and a second signal 62 detected in broadband fashion, of an optical sensor of a means of transportation. First signal 60 represents a signal that is detected by the optical sensor when a roadway surface is covered with snow in such a way that the latter is present only in pores of the roadway surface, and the roadway surface is thus not completely covered with snow. Second signal 62 represents a signal that is detected by the optical sensor when the roadway surface is covered with a thin layer of ice. It is apparent from the comparative example that values of reflection factors of the first and the second signal differ sufficiently from one another that a classification of the respective signal in terms of a snow-covered or an ice-covered roadway can be carried out on the basis of the method according to the present invention.

FIG. 3b shows a comparative example of a spectrum of a third signal 64 detected in broadband fashion, and a fourth signal 66 detected in broadband fashion, of an optical sensor of a means of transportation. Third signal 64 represents a signal that is detected by the optical sensor when a roadway surface is completely covered with a continuous layer of snow. Fourth signal 66 represents a signal that is detected by the optical sensor when the roadway surface is covered with a thick layer of ice. It is apparent from the comparative example that values of reflection factors of the third and the fourth signal differ from one another sufficiently that a classification of the respective signal in terms of a snow-covered or an ice-covered roadway can be carried out on the basis of the method according to the present invention.

1-10. (canceled)

11. A method for ascertaining a solid physical state of water on a roadway surface, comprising the following steps:
emitting light of a light source of an optical sensor of a transportation device at a predefined angle onto the roadway surface, the light source being configured to emit the light having at least two predefined wavelengths or predefined wavelength ranges which differ from one another;
receiving a signal of a light detector of the optical sensor, representing an intensity of a portion of the emitted light which is scattered back by the roadway surface to the optical sensor;
ascertaining a solid physical state of water on a roadway surface based on a ratio of received values for light intensities of the respective predefined wavelengths or predefined wavelength ranges within the signal;
classifying the solid physical form of water on the roadway surface by: (i) reconciling absolute values of the signal with a first predefined threshold value, and/or (ii) reconciling a signal-to-noise ratio of the signal with a second predefined threshold value; and
using ascertained information regarding the solid physical state of the water in the transportation device.

12. The method as recited in claim 11, wherein the light source:
encompasses a single light-emitting device or a plurality of light-emitting devices; and/or
is a laser light source or an LED light source; and/or
is embodied to emit near-infrared light whose wavelength lies in a range between 800 nm and 3000 nm.

13. The method as recited in claim 11, wherein the predefined angle of the optical sensor of the transportation device with respect to the roadway surface is an angle of between 10° and 54°.

14. The method as recited in claim 11, wherein the predefined angle of the optical sensor of the transportation device with respect to the roadway surface is an angle of between 15° and 35°.

15. The method as recited in claim 11, wherein the predefined angle of the optical sensor of the transportation device with respect to the roadway surface is an angle of 20°.

16. The method as recited in claim 11, wherein an information item regarding a current degree of deflection of a suspension system of the transportation device is taken into account upon reconciliation of the absolute values of the signal with the first predefined threshold value.

17. The method as recited in claim 11, wherein the classification of the solid physical state of water on the roadway surface is additionally carried out based on further sensors of the transportation device.

18. The method as recited in claim 11, further comprising:
ascertaining a layer thickness of the water in its respective solid physical state based on the signal.

19. The method as recited in claim 11, wherein the solid physical state of water on the roadway surface is ascertained based on a machine learning method.

20. The method as recited in claim 11, further comprising:
ascertaining a confidence value for the solid physical form of the water; and
using the confidence value in the transportation device.

21. The method as recited in claim 11, wherein a plurality of signals of the optical sensor, which have each been received at different positions of the transportation device, are taken into account upon classification of the solid physical state of the water.

22. An apparatus for ascertaining a solid physical state of water on a roadway surface, comprising:
an evaluation unit;
a data input; and
a data output;
wherein the evaluation unit is configured to:
in conjunction with the data output, emit light of a light source of an optical sensor of a transportation device at a predefined angle onto a roadway surface, the light source being configured to emit the light having at least two predefined wavelengths or predefined wavelength ranges that differ from one another;
in conjunction with the data input, receive a signal of a light detector of the optical sensor representing an intensity of a portion of the emitted light which is scattered back by the roadway surface to the optical sensor;
ascertain a solid physical state of water on a roadway surface based on a ratio of received values for light intensities of the respective predefined wavelengths or predefined wavelength ranges within the signal;
classify the solid physical state of water on the roadway surface by:
(i) reconciling absolute values of the signal with a first predefined threshold value, and/or
(ii) reconciling a signal-to-noise ratio of the signal with a second predefined threshold value; and
in conjunction with the data output, use the classified solid physical state of the water in the transportation device.
